(19) United States
(12) Patent Application Publication
(10) Pub. No.: US 2011/0007975 A1
(43) Pub. Date: Jan. 13, 2011

(54) Image Display Apparatus and Image Display Method

(75) Inventors: Hisashi Kazama, Kanagawa (JP); Kei Takizawa, Kanagawa (JP); Tomokazu Wakasugi, Tokyo (JP); Yosuke Bando, Tokyo (JP)

Correspondence Address: SPRINKLE IP LAW GROUP, 1301 W. 25TH STREET, SUITE 408, AUSTIN, TX, 78705, US

(73) Assignee: Kabushiki Kaisha Toshiba, Tokyo (JP)

(21) Appl. No.: 12/833,255

(22) Filed: Jul. 9, 2010

(30) Foreign Application Priority Data
Jul. 10, 2009 (JP) 2009-164077

(51) Int. Cl. G06K 9/62

(52) U.S. Cl. 382/225

(57) ABSTRACT

According to embodiments, an image display apparatus includes: a face detection processing section configured to detect face areas included in video content to generate face cut-out images including the face areas; a face clustering processing section configured to group a plurality of face cut-out images included in the video content by respective characters of the video content to classify clusters corresponding to the characters; an evaluation section configured to obtain evaluation values by evaluating the plurality of face cut-out images in relation to one or more evaluation items among a plurality of evaluation items corresponding to a plurality of features included in the face cut-out images; and a selection section configured to select face cut-out images in which evaluation values are within a predetermined range from among the plurality of face cut-out images in the clusters as representative face icon images used for display.

### CROSS-REFERENCE TO RELATED APPLICATION(S)

This application is based upon and claims the benefit of priority from Japanese Patent Application No. 2009-164077 filed on Jul. 10, 2009, the entire contents of which are incorporated herein by reference.

### BACKGROUND

1. Field

Embodiments described herein relate generally to an image display apparatus and a method configured to use a processing result of face clustering to display a face image.

2. Description of the Related Art

In recent years, along with digitalization of video and expanded capacity of storage media, a study of a video indexing technique is underway to search a desired scene from a large amount of video content. Utilizing the video indexing technique allows, for example, searching an appearance scene of each character.

An image recognition technique, such as face detection, is used for the search. Japanese Patent Application Laid-Open Publication No. 2008-83877 (hereinafter, “Document 1”) discloses an information processing apparatus configured to search a video, the face of a person being a key. However, in the invention of Document 1, only face images similar to pictures of faces registered in advance can be detected, and faces in different sizes, orientations, brightness, contrast, backgrounds, brightness of surrounding, photographing times, expressions, etc. cannot be detected.

Meanwhile, Document 2 (Japanese Patent Application Laid-Open Publication No. 2005-134966) discloses a face image candidate area search method configured to detect a face included in video content. Using a face detection process according to the invention allows searching what kind of persons appear in each scene.

However, search results of a same person may continue when all faces included in the video content are detected and just displayed. Therefore, a search of a scene, etc. may not be easy. Thus, a technique for grouping the detection results of the same person, i.e. a face clustering process, is adopted.

In Document 3 (Osamu Yamaguchi and Kazuhiro Fukui “‘Smart face’: A Robust Face Recognition System under Varying Facial Pose and Expression”, The Transactions of the Institute of Electronics, Information and Communication Engineers, D-II, vol. J84-D-II, no. 6, pp. 1045-1052, June 2001), a technique of a face clustering process is described in detail. The technique disclosed in Document 3 is a technique for calculating the similarity between a subspace generated based on a face image registered in advance and a subspace generated based on a face image in a video to authenticate a person.

The execution of the face clustering process allows efficient display of a person appearing in the video content, and a search of a scene, etc. is facilitated.

Characters in the video content may be displayed by face images in various applications using processing results of the face clustering process. For example, in a scene search, etc., associating the display using face images acquired from the video content with the scenes allows identifying a scene to be referenced in the face images.

However, the size, orientation, brightness, contrast, background, brightness of surrounding, expression, etc. of the detected face images are different in each scene, and there is no uniformity in the displayed face images of the persons. Furthermore, checking of the faces is difficult in some face images, and there is a problem that sufficient display quality is not attained.

### BRIEF DESCRIPTION OF THE DRAWINGS

FIG. 1 is a block diagram showing an image display apparatus according to a first embodiment of the present invention;

FIG. 2 is an explanatory diagram for explaining a face detection process and a face clustering process used in a video indexing process adopted in the present embodiment;

FIG. 3 is a flow chart showing a procedure of storing evaluation values;

FIG. 4 is a flow chart showing a selection method of representative face icon images;

FIG. 5 is a flow chart showing an action when a representative face icon image is selected using a plurality of evaluation items;

FIG. 6 is a flow chart specifically showing a filtering process in FIG. 5;

FIG. 7 is an explanatory diagram showing a cast icon display;

FIG. 8 is an explanatory diagram showing a pop-up face icon display;

FIG. 9 is an explanatory diagram showing an appearance timeline display;

FIG. 10 is a flow chart showing a filtering process;

FIG. 11 is a flow chart showing a filtering process;

FIG. 12 is a flow chart showing a second embodiment of the present invention;

FIG. 13 is a flow chart showing a third embodiment of the present invention; and

FIG. 14 is a flow chart showing a fourth embodiment of the present invention.

### DETAILED DESCRIPTION

Embodiments of the present invention will be described in detail below with reference to the drawings.

According to embodiments, an image display apparatus including: a face detection processing section configured to detect face areas included in video content to generate face cut-out images including the face areas; a face clustering processing section configured to group a plurality of face cut-out images included in the video content by respective characters of the video content to classify clusters corresponding to the characters; an evaluation section configured to obtain evaluation values by evaluating the plurality of face cut-out images in relation to one or more evaluation items among a plurality of evaluation items corresponding to a plurality of features included in the face cut-out images; and a selection section configured to select the face cut-out images in which evaluation values are within a predetermined range from among the plurality of face cut-out images in the clusters as representative face icon images used for display.

### First Embodiment

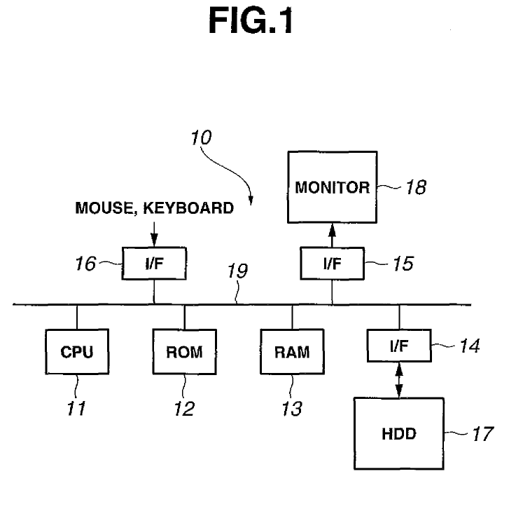

FIG. 1 is a block diagram showing an image display apparatus according to a first embodiment of the present invention.

An image display apparatus 10 is an information processing apparatus including a central processing unit (CPU) 11, a ROM 12, a RAM 13, interface sections 14 to 16 (hereinafter “I/F”), etc. The image display apparatus 10 can be constituted by a personal computer (PC), etc. The ROM 12 stores an image processing program for a video indexing process, etc. The RAM 13 is a storage area for work of the CPU 11. An embedded or external hard disk drive (hereinafter, “HDD”) 17 is connected to the I/F 14. The HDD 17 stores moving image data (video content), etc.

A monitor 18 is connected to the I/F 15. The monitor 18 is configured to be able to display images, video indexing processing results, etc. Input devices, such as a keyboard and a mouse, are connected to the IN 16. The I/F 16 provides operation signals from the input devices to the CPU 11. The CPU 11, the ROM 12, the RAM 13, the I/Fs 14 to 16 are connected to each other through a bus 19.

The CPU 11 reads out and executes a video indexing program stored in the ROM 12. More specifically, the CPU 11 applies a video indexing process to stream data (video content) of moving images read out from the HDD 17.

The program for the video indexing process may be stored in the HDD 17. In that case, the CPU 11 reads out and executes the program for the video indexing process stored in the HDD 17.

The image display apparatus 10 is constituted by an information processing apparatus such as a PC in the example described in the present embodiment. However, the image display apparatus may be incorporated into, for example, a TV receiver configured to store stream data of TV broadcast, an HDD recorder with TV reception function, or an apparatus configured to store stream data, etc. distributed through a network. For example, if the image display apparatus is incorporated into a TV receiver, the CPU 11 can apply the video indexing process to receiving video content in real time while receiving stream data of TV broadcast.

Not only by a CPU, but also a CPU and coprocessors (processing apparatuses called a stream processor, a media processor, a graphics processor, or an accelerator that are separate from the CPU) may collaborate to execute the video indexing process. In that case, an apparatus including the coprocessors and the CPU can be considered as a “CPU” for the understanding of the configuration of the present embodiment with reference to FIG. 1.

The video indexing process is a process for processing video content to create significant index information. For example, an example of the video indexing process includes a process of providing an index to each image of recognized faces using a face recognition technique. The video indexing process allows viewing only the scenes of a specific performer in moving image data, such as a TV program, and allows efficient view of the video content. Not only the efficient view, but advantages of video indexing include abundant advantages, such as supporting abundant creative activities and viewing the video content from different viewpoints and through edits to obtain a new thrill.

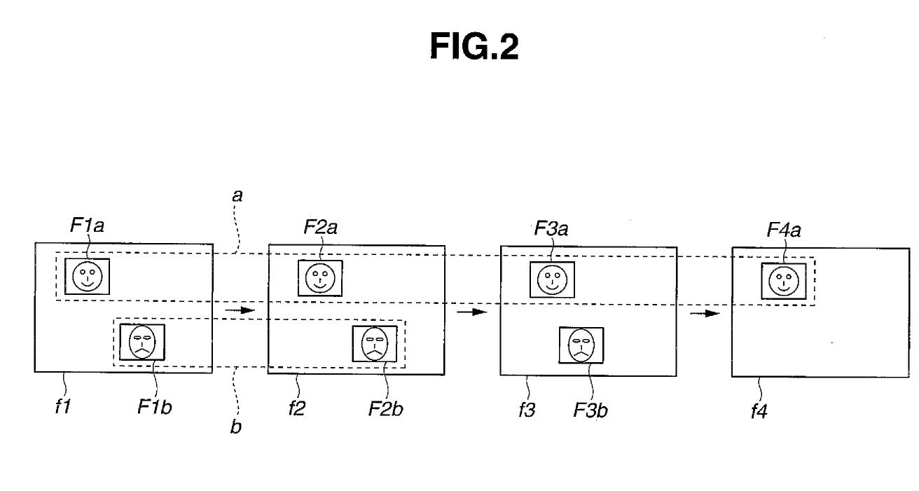

A face detection process and a face clustering process used in the video indexing process adopted in the present embodiment will be described with reference to an explanatory diagram of FIG. 2.

### (Face Detection Process)

The CPU 11 reads out the video content from the HDD 17 to execute the face detection process. The CPU 11 can also apply the face detection process to the receiving video content in real time while receiving the stream data of TV broadcast.

More specifically, the CPU 11 first applies video processing to moving images to form a sequence of still images called frames or fields. FIG. 2 illustrates such temporally consecutive still images f1 to f4. The CPU 11 detects areas of faces from the still images. For example, the CPU 11 can adopt a method disclosed in Document 4 (Japanese Patent Application Laid-Open Publication No. 2006-268825) to detect the areas of faces from the still images. To apply Document 4 to the face image detection of the still images, sample images to be learned can be set to “many face images” for learning in a preliminary learning stage. In a subsequent stage of processing, a process of determining whether face images are included in partial image areas in various positions and sizes in the still images can be repeated.

When the face detection process is applied to the moving image content, a significantly large number of face images can be obtained. The images are grouped by person, i.e. a face clustering process is executed. The face clustering process is divided and executed in two processing steps, a “face sequence creation process” and a “face clustering process using a face image processing technique”.

### (Face Sequence Creation Process)

In a first processing step, (temporally) consecutive face images of a same subject are collected (grouped) to create a face sequence. This will be referred to as a “face sequence creation process”.

An object of the “face sequence creation process” is to make a set called a “set of face images” for the “face clustering process using a face image recognition technique” of the second step.

Each still image includes face images in various locations and sizes. Persons in the face images are different, and expressions, brightness, contrast, orientations of faces, etc. are also different. Particularly, in TV broadcast, shapes, etc. of the face of the same person in the still image sequence are often different depending on differences in the makeup, hairstyle, role, etc. For this reason, grouping of single face images by the person is difficult even if the face image recognition technique is used.

Therefore, a method of collecting various (with some variations) face images of the same person to apply face clustering to each set of face images is adopted. The “face sequence” is created to make the “set of face images”. The “face sequence creation process” is executed as follows.

The CPU 11 uses a predetermined face dictionary to identify areas of faces from the still images and cuts out images including surroundings of the areas of faces. Areas F1a to F4a and F1b to F3b of FIG. 2 denote the areas of images cut out by the CPU 11 (hereinafter, “face cut-out area”). The CPU 11 stores images of the face cut-out areas (hereinafter, “face cut-out image”) in a file separate from the video content. In this case, the CPU 11 may normalize the face images based on the face size. The CPU 11 may also store the face cut-out images after normalizing the size and the quality of the images.

At the same time as the face detection described above, the CPU 11 obtains temporal similarity between the still image sequences as well as the continuity of detection locations of the face images. More specifically, the CPU 11 stores and compares locations and sizes on the screen of the areas of the face images (hereinafter, “face areas”) in the still images and determines face areas with small variations in the locations and the sizes between a plurality of consecutive still images as face areas of a same subject.

In the example of FIG. 2, the areas F1a to F4a are determined to include face areas of the same subject. In the same way, the areas F1b and F2b are determined to include the same subject, and the area F3b is determined to include a face area of a different subject. The locations and the sizes of face images of different subjects may be substantially the same in consecutive frames before and after a camera switch point. Therefore, in consideration of such a case, etc., the CPU 11 calculates a feature amount of the tone of the entire screen and of a luminance arrangement pattern for each frame and estimates a point where the feature amount suddenly varies as a shot switch (cut) to prevent erroneously determining the face images of different subjects as the face images of the same subject.

To most simply execute the process, for example, inter-frame differences can be consecutively calculated for the video content, and it can be determined that there is a cut if the variation is greater than a predetermined setting value. More specifically, it can be determined that there is a cut if there is a change in one of the locations and sizes of the face images, the inter-frame differences of the areas of the face images, and the inter-frame differences of the background (or entire screen). In the processing step, an erroneous detection of a cut does not pose a large problem. On the other hand, a missed detection of a cut when a person is replaced is more problematic. Therefore, the detection sensitivity of the cut points is set acutely.

The CPU 11 defines a set of consecutive face images of the same subject in the sequence of consecutive still images as a face sequence. More specifically, one face sequence includes only a plurality of temporally consecutive face images estimated to be the same subject. For example, in the example of FIG. 2, a face sequence a is generated from four face images of the areas F1a to F4a, and a face sequence b is generated from two face images of the areas F1b and F2b.

A plurality of face sequences of the same subject can be detected in one video content. For example, assuming that 10000 face sequences in total are detected from the video content, and assuming that there are ten main characters in the video content, the face sequences are divided into 1000 face sequences per person on average and detected.

### (Face Clustering Process)

The “face clustering process using a face image processing technique” as a second processing step is then executed. The “face clustering process using a face image recognition technique” is a process of integrating (grouping) the generated face sequences for each same person based on an image recognition technique.

The CPU 11 first detects locations of parts, such as eyes, nose, mouth, and eyebrows, of the face images in the face sequences and converts all face images in the face sequences into images of faces facing the front (hereinafter, “normalized image”) based on the parts locations of a basic model. The CPU 11 then applies a feature extraction process to normalized face image sequences in the face sequences and creates subspaces of the sequences. The CPU 11 creates subspaces of all face sequences in the video content. The CPU 11 handles data of the subspaces as a dictionary of the face sequences and executes the following “integration process of face sequences”.

A method of creating subspaces from a series of image sequences (obviously, including face image sequences) and a method of calculating the similarity between the subspaces are described in detail in Document 5 (Osamu Yamaguchi and Kazuhiro Fukui “‘Smart face’: A Robust Face Recognition System under Varying Facial Pose and Expression”, The Transactions of the Institute of Electronics, Information and Communication Engineers, D-II, vol. J84-D-II, no. 6, pp. 1045-1052, June 2001).

In the creation of the subspaces, instead of setting the luminance distribution of face images as image features of the image sequence, the CPU 11 may adopt a method of cutting out partial images and performing mathematical or geometric conversion to extract the features. There are various forms in the extraction method of the image features. The number of dimensions of the image features is high in the present embodiment, and the compression of the dimensions into subspaces is basically described. However, if the number of dimensions of feature vectors of the face sequences is not high, a variation, such as setting the feature vectors as dictionary data, may be adopted without adopting the subspace method. Furthermore, instead of the method of using the image features, a method, such as using partial areas of images and executing an integration process of the face sequence based on image matching with other face sequences, can be adopted. As described, there are various methods for the information and the feature amounts to be extracted for the following “integration process of face sequences”. In any event, a procedure of creating the “face sequences” to execute the “integration process of face sequences” is common.

Subsequently, the “integration process of face sequences” is executed.

A plurality of face sequences are detected for a same person. Therefore, the face sequences of the same person are merged. More specifically, the CPU 11 calculates the similarity between the subspaces of the face sequences and determines whether the face sequences detected in the video content are face sequences of the same person or face sequences of another person. For example, the CPU 11 uses a round robin chart thereinafter, “similarity matrix”), in which face sequences are vertically and horizontally aligned, to calculate the similarity between the subspaces of the face sequences in a round robin manner and integrates the face sequences, in which the similarity is greater than a predetermined threshold.

The similarity matrix is a large-scale sequence in many cases. Therefore, the CPU 11 may scale down the round robin, set a priority order for calculation, or create a hierarchical similarity matrix for hierarchical analysis before advancing the similarity calculation for the similarity matrix.

A mutual subspace method, etc. can be adopted as a calculation method of the similarity between the subspaces (i.e. between face sequences). Details of the mutual subspace method are described in detail in, for example, Document 6 (“Pattern Matching Method Implementing Local Structure”, The Transactions of the Institute of Electronics, Information and Communication Engineers (D), vol. J68-D, no. 3, pp. 345-352, 1985). Although there are various forms in the calculation method of the similarity between the subspaces, the process that needs to be carried out is calculating the similarity between the face sequences and determining whether the face sequences indicate the same person.

The CPU 11 uses all normalized images included in the integrated face sequences to again compute the subspaces for the integrated face sequences and uses the subspaces in the following similarity calculations. The integration of the face sequences increases face images included in the face sequences. More perturbations (slight variations caused by expressions, face orientations, etc.) of the face images are included in the face sequences, and the feature amounts for calculating the similarity spatially spread. The spatial spread of the feature amounts speeds up the integration of the face sequences.

The size of the similarity matrix gradually decreases after repetition of the integration of the face sequences. The face clustering process ends once the reduction of the similarity matrix settles.

In this way, the face sequences with high similarity are grouped. A group of face sequences will also be referred to as a “cluster”. There are two types of errors in clustering when the face clustering process is executed. The first is an “excessive cluster merger error”. This error means that measurement of “precision” is not good. The second is an “excessive cluster split error”. This error means that measurement of “recall” is not good. Although depending on the application method of the face clustering result, the first error is usually more problematic. Therefore, the threshold of similarity is usually set high to avoid excessive cluster merger of the face sequences of different persons. As a result, the face sequences of the same person may not be integrated. For example, 2000 face sequences may remain even if there are five characters in the video content. However, even in that case, if the clusters are selected in descending order of the number of face images included in the clusters, most face images in the video content are often included in, for example, about 10 clusters. Therefore, there is no problem in practical use.

### (Display Process)

In the present embodiment, examples of displaying the face clustering results in the following three display formats will be described.

A first example is an application for displaying representative characters of the video content by face icon images. The face icon images in the example will be referred to as cast icons, meaning icons indicative of roles, and the display will be referred to as cast icon display. In the cast icon display, representative characters in the video content can be recognized before the selection of a file of the video content.

A second example is an application for pop-up display of representative faces of characters in a cut designated on a timeline. The face icon images in the example will be referred to as pop-up face icons, and the display will be referred to as pop-up face icon display. In the pop-up face icon display, characters in a predetermined partition (chapter) can be recognized without the reproduction of the content in a scene for which the video content will be edited.

A third example is an application for displaying appearance scenes of each person on a time axis (timeline), and the display will be referred to as appearance timeline display. In the appearance timeline display, the content can be simply surveyed in the selection of a reproduction point of the content for reproduction.

In the present embodiment, the CPU 11 is configured to evaluate the face images by various evaluation methods in the face detection process. The CPU 11 is configured to associate an evaluation value as an evaluation result with each face image and store the face image. As described, the CPU 11 is configured to store the images of face cut-out areas (face cut-out images) in a file separate from the video content. The CPU 11 stores various evaluation values in association with the face cut-out images to be stored. The CPU 11 is configured to use the stored face cut-out images as face icon images used for various displays.

In the present embodiment, the CPU 11 is configured to select an image among the face cut-out images included in the clusters based on the evaluation values stored in association with the face cut-out images and use the image as a face icon image for display.

For example, the CPU 11 can use degree of frontality as an evaluation value. In the face detection process, the CPU 11 evaluates the similarity between the face dictionary and the parts of the images. In the face detection process, the face dictionary is designed to react to face images of various persons and face images of various expressions, instead of reacting to the face of a specified individual. Therefore, in general, the evaluation value of an image of a clear (sufficient contrast, no blur, and close to front light) face facing the front is high. The CPU 11 uses the face cut-out image with the highest evaluation value among the clusters, i.e. the face cut-out image with the highest degree of frontality, as the face icon image (hereinafter, “representative face icon image”).

The CPU 11 makes the sizes of the face cut-out images the same before storing the images or normalizes the sizes of the faces in the face cut-out images selected as the representative face icon images to make the image sizes uniform before use. As a result, there is uniformity in the size of the face icons in the displays or in the size of the faces in the face icons, and the images can be easily viewed.

However, if the face cut-out images are selected based simply on the evaluation values for face detection, other image features, such as brightness, contrast, gamma correction and tone, or orientations of face, expressions, etc. may not be uniform. For example, if there is a clear image facing the right front by chance in the detected face images, the image may be selected. However, if only faces facing to the right or facing down are actually included, a face image relatively close to the front side is just selected. Furthermore, the evaluation values for face detection are not determined only by the face orientations, but are determined influenced by whether the expressions are average or by the clarity of the images. Therefore, if the face cut-out images are selected based simply on the evaluation values for face detection, there are the following drawbacks in which the displays are not uniform, and the display quality is insufficient.
The orientations of the faces of the persons are not uniform. Some people face right or face down etc.
Some faces are dark or bright, and average luminance is not uniform in some cases.
The contrast and the clarity are different in some faces.
The backgrounds and the illumination conditions are not uniform, and the hue (tone, color balance, white balance, and saturation) is inconsistent.

The present embodiment allows not only to select easily viewable images as individual representative face icon images, but also to select uniform representative face icon images as a whole. Therefore, the CPU 11 is configured to evaluate the images in various ways during the face detection process and associate the evaluation values with the face cut-out images before storing the images.

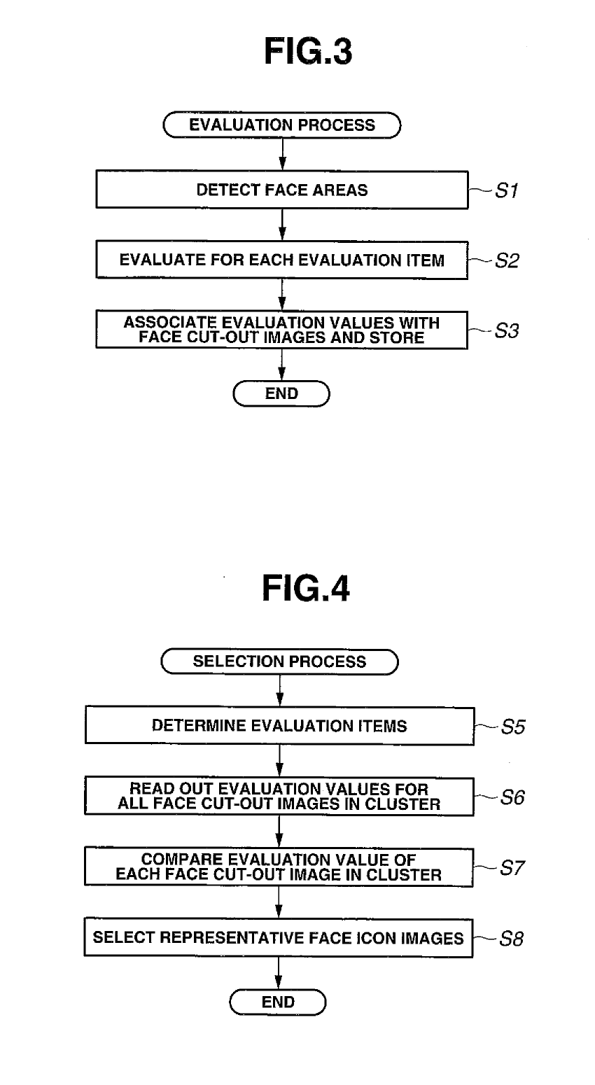

FIG. 3 is a flow chart showing a procedure of an evaluation process. FIG. 4 is a flow chart showing a selection method of representative face icon images. In the example of FIG. 4, the representative face icon image is selected in accordance with one or a plurality of evaluation values in each cluster.

The CPU 11 detects face areas in step S1 and evaluates face images or face cut-out images during the detection in relation to each evaluation item (step S2). The CPU 11 stores evaluation values in association with the face cut-out images identified by image Nos. (step S3). The following Chart 1 shows an example of the evaluation items.

CHART 1

| | | | | | |
|---|---|---|---|---|---|
| Degree of | Average | Tone | Focus | Background | Orientation |
| frontality | Luminance | (Color | (Sharpness) | clarity | of Face |
| | | balance) | | | |
| Contrast | Image | Lighting | Saturation | Degree of | |
| | Location | position | | Smile | |

As shown in Chart 1, the evaluation items can include degree of frontality, contrast, average luminance, tone (color balance), focus (sharpness), lighting position, image location, degree of smile, saturation, orientation of face, background clarity, etc. The evaluation values detected for the evaluation items may be stored as the evaluation values of the items, or the evaluation values may be classified in stages to store values provided to the classifications. For example, as for the orientation of face, an angle in vertical and horizontal directions may be stored based on the front side, or the vertical and horizontal directions may be divided into eight directions to store in which direction the person is facing. As for the degree of smile, for example, the similarity with an image as an evaluation standard of the smile may be stored, or a value indicating to which stage the degree of smile belongs may be stored.

As for the focus, only the face images in the face cut-out images are evaluated. For example, the CPU 11 can apply a two-dimensional Fourier transform to the face images to determine the power of the spectrum of high-frequency area as the evaluation values of the focus. In that case, the CPU 11 can determine the face image with the highest evaluation value as the face image with the best focus.

For the cast icon display, etc., the CPU 11 first determines an evaluation item as a standard of selection in step S5. For example, the CPU 11 selects “Focus” as an evaluation item. For each cluster, the CPU 11 reads out and compares the evaluation values of the focus in relation to the face images of all face cut-out images included in the cluster (step S7) and selects the face cut-out image corresponding to the highest evaluation value as a representative face icon image (step S8).

In this way, the focused representative face icon image can be used for the cast icon display, etc. Therefore, not only the face icon image with high degree of frontality, but also the focused face icon image can be displayed, and the visibility is excellent.

Furthermore, in the present embodiment, a plurality of evaluation items of Chart 1 can be selected, and the representative face icon image can be selected based on a plurality of evaluation values. In that case, setting a priority order to the evaluation items allows selecting a most easily viewable face icon image.

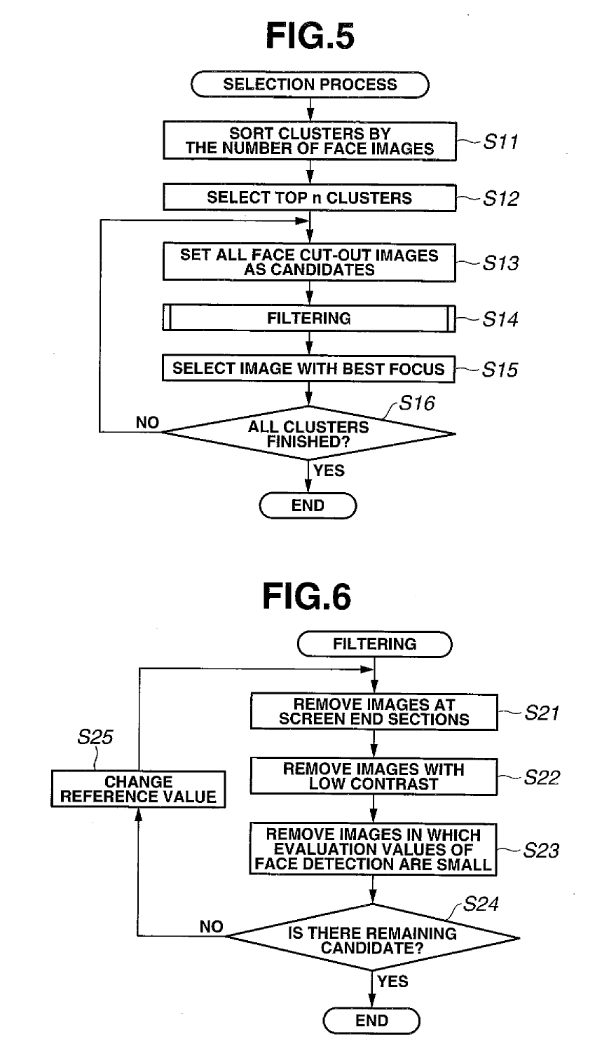

FIG. 5 is a flow chart showing an example of an action when a plurality of evaluation items are used to select the representative face icon image.

Now, it is assumed that the CPU 11 executes the cast icon display. In that case, the CPU 11 sorts all clusters in the video content by the number of face images included in the clusters in step S11. The CPU 11 selects top n clusters in terms of the number of face images in step S12. More specifically, the CPU 11 uses the clusters corresponding to persons with more number of times of display of the faces to display the clusters as cast icons.

The CPU 11 may select the clusters not only by the number of face images, but also in descending order of the sum of the display time of the face images. A person who appears throughout substantially the entire time zone of the video content may be an important person, such as a host and a main character. Therefore, the CPU 11 may select the clusters in descending order of the length of time from the first appearance in the video content to the last appearance.

The CPU 11 then sets all face cut-out images of the selected clusters as candidates of the representative face icon images (step S13). In the present embodiment, the CPU 11 performs filtering in step S14. As a result of the filtering, for example, only images in good quality are selected from the entire face cut-out images.

FIG. 6 is a flow chart specifically showing the filtering process in FIG. 5. As shown in FIG. 6, the CPU 11 first removes images at screen end sections among all face cut-out images from the candidates of the representative face icon images. The face cut-out images include images around the face images. Therefore, if a face image is located at a screen end section, the face cut-out image includes an area outside the screen, and the part is displayed, for example, entirely black, which degrades the screen quality. Thus, if more than a certain ratio of a one-colored area exists in the face cut-out image, with a ratio of the area outside the screen included in the face cut-out image being supposed to be a protrusion ratio, the CPU 11 determines that the protrusion ratio exceeds a threshold and removes the face cut-out image from the candidates for the representative face icon images.

The CPU 11 then calculates contrast values of the candidates for the representative face icon images and removes face cut-out images including contrast values smaller than a predetermined threshold from the candidates for the representative face icon images. For example, the CPU 11 sets a luminance difference between top 10% luminance values and bottom 10% luminance values as a contrast value and determines images with the values smaller than a predetermined threshold as low-contrast images to remove the images from the candidates for the representative face icon images. As a result, images with small contrast, i.e. unclear images, are removed from the candidates for the representative face icon images.

In step S23, the CPU 11 removes face cut-out images in which the evaluation values of face detection are smaller than a predetermined threshold from the candidates for the representative face icon images. In the face detection process, various evaluation values, such as similarity values using the face dictionary, evaluation values related to the detection of face parts (eyebrows, eyes, mouth, nose, etc.), and evaluation values of degree of frontality computed from the positional relationship between the face parts, are used to detect the face areas from the images. The CPU 11 weights the evaluation values to obtain evaluation values of face detection based on linear sums, etc. and compares the evaluation values with the threshold to make determinations. In images with high evaluation values, the face areas and the backgrounds can be distinguished with high reliability.

In step S24, the CPU 11 determines whether there are one or more candidates for the representative face icon images. If there is no candidate, the process moves to step S25. The reference values in steps S21 to S23, such as protrusion ratios, contrast values, and evaluation values in face detection, are alleviated (That is, the candidates are increased. For example, the reference values are changed in some cases, the threshold as a comparison value is changed in other cases) to repeat the processes of steps S21 to S23 so that one or more candidates for the representative face icon images remain at the determination of step S24.

Preferably, the CPU 11 changes the reference values so that, for example, about 10% of images among all face cut-out images in the clusters remain as the candidates for the representative face icons. Optimal values for the reference values can be obtained by trial and error in accordance with an application using the representative face icon images.

Once the filtering process is finished, the CPU 11 selects an optimal face icon from the candidates for the representative face icon images in the following step S15. For example, in the example of FIG. 5, the CPU 11 selects the face cut-out image with the best focus as the representative face icon image.

In step S16, the CPU 11 determines whether the processes are finished for all clusters. If the processes are not finished, the CPU 11 repeats the processes of steps S13 to S15 for the next cluster. In this way, the representative face icon images used for display are determined for all clusters.

The order of the filtering processes S21, S22, and S23 shown in FIG. 6 can be switched.

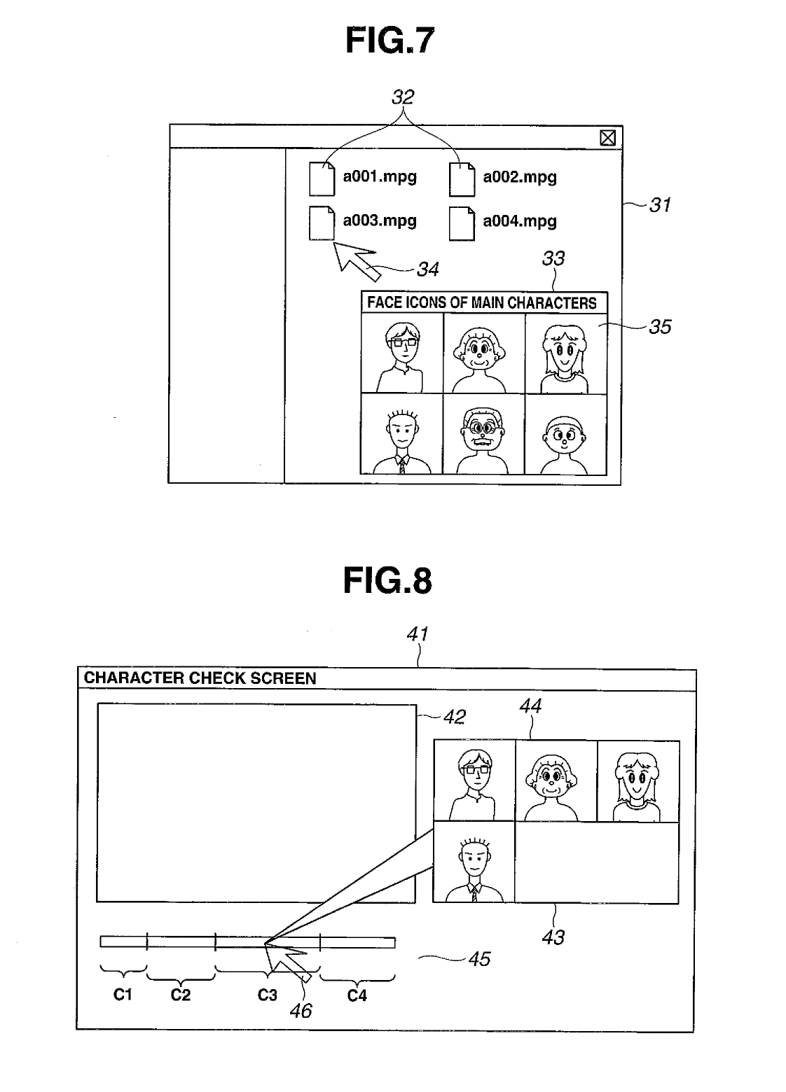

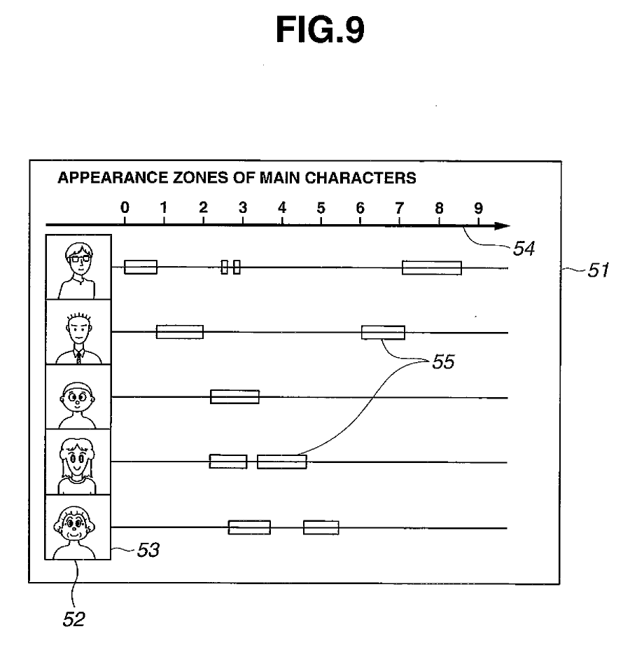

FIGS. 7 to 9 are explanatory diagrams showing an example of various displays using the selected representative face icon images. FIG. 7 shows a cast icon display. FIG. 8 shows a pop-up face icon display. FIG. 9 shows an appearance timeline display.

FIG. 7 illustrates an example of displaying a cast icon display on a selection screen 31 of the video content. Icons 32 denote content files of the video content, and file names of the content files are displayed near the icons 32. The example of FIG. 7 shows that four content files can be selected on the selection screen 31. The CPU 11 moves a cursor display 34 on the selection screen 31 in accordance with operation of a mouse, etc. For example, as the user moves the cursor display 34 on to the icon 32, the CPU 11 can display main characters of the video content designated by the icon 32 through representative face icon images.

For example, the CPU 11 displays the representative face icon images of the video content designated by a mouse, etc. on a cast icon display area 33. In this case, for example, the CPU 11 displays the representative face icon images corresponding to top several persons with many appearances as the main characters. In the example of FIG. 7, representative face icon images 35 of six persons of the video content with a file name a000.mpg are displayed on the cast icon display area 33.

FIG. 8 shows an example of displaying a pop-up face icon display on a character check screen 41. A video of the video content is displayed in a display area 42. Below the display area 42, a chapter display 45 showing chapters of the content displayed on the display area 42 is displayed. The example of FIG. 8 illustrates that the video content currently displayed on the display area 42 includes four chapters C1 to C4.

The CPU 11 moves a cursor display 46 on the character check screen 41 in accordance with operation of a mouse, etc. For example, as the user moves the cursor display 46 to an arbitrary location on the chapter display 45, the CPU 11 can display the characters in a chapter period designated by the cursor display 46 through the representative face icon images.

For example, the CPU 11 displays the representative face icon images of the characters in the chapter period designated by the mouse, etc. on the pop-up face icon display area 43. In the example of FIG. 8, representative face icon images 44 of four characters in the chapter C3 are displayed on the pop-up face icon display area 43.

FIG. 9 illustrates an example of display of an appearance timeline display. An appearance timeline display 51 includes a character display area 52, a time display 54, and an appearance period display 55. The CPU 11 displays representative face icon images 53 of main characters of the video content in the character display area 52. In this case, for example, the CPU 11 displays the representative face icon images 53 corresponding to top several persons with many appearances as the main characters. A line extending from each representative face icon image 53 denotes a time axis of the video content, and the appearance period display 55 on the time axis indicates appearance periods of the characters.

In the displays showing in FIGS. 7 to 9, for example, representative face icon images with the best focus are selected and displayed in accordance with the selection process shown in FIG. 5. Therefore, the display quality is excellent, and checking of the characters is extremely easy.

Various evaluation items can be considered for selecting the representative face icon images as shown in the example of Chart 1. For example, evaluation items not related to the image quality can be used, and the orientation of the face and the degree of frontality can be set as the evaluation items. Various methods can be considered for determining the degree of frontality in the face imaging process. For example, it may be determined that the person is facing the front if left and right pupils are detected. Parts of the face, such as eyebrows, eyes, nose, and mouth, may be detected, and it can be determined that the person is facing the front in an image with higher horizontal symmetry. Furthermore, it can be determined that the person is facing the front if the similarity with the dictionary data of the face facing the front is greater. An evaluation can also be made based on the height of the face determination value of the face detection process.

However, if the evaluation values related to the degree of frontality in the face detection process are used to select the representative icon images, the persons may face any directions, such as to the right, to the left, up, and down, depending on the images. Furthermore, for example, the character display area 52 is arranged on the left end of the screen in the appearance timeline display, etc. of FIG. 9. Therefore, images of the faces facing to the right (direction on the screen, i.e. direction that the face images face toward the timeline) look better as the representative face icon images 53.

In that case, face cut-out images in which the orientation of face as the evaluation value is to the right can be selected as the representative face icon images.

Furthermore, for example, only the images in which the orientation of face is to the right can be set as the candidates for the representative face icon images by a filtering process.

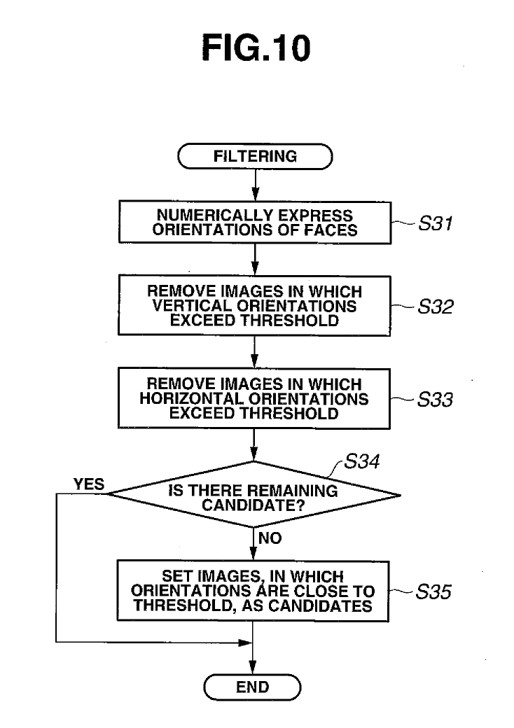

Therefore, in place of or in addition to the filtering process of FIG. 6, the CPU 11 may execute a filtering process shown in a flow chart of FIG. 10.

More specifically, in step S31 of FIG. 10, the CPU 11 numerically expresses the orientation of face in each cluster. For example, the CPU 11 numerically expresses how much an axis indicating the front side of the face in a face cut-out image is vertically and horizontally deviated. The orientation of the face can be obtained by detecting the locations of the face parts, such as eyebrows, eyes, nose, and mouth, and performing three-dimensional motion analysis based on a difference in two-dimensional locations between the positions of the parts and an arrangement model of the parts facing the front. The CPU 11 obtains three-dimensional conversion parameters (translational direction and quantity of translational motion as well as rotational axis and rotational angle, mathematically, translation matrix and rotation matrix) of face relative to the arrangement model of the parts facing the front to numerically express the orientation of the face.

The CPU 11 removes images in which the vertical orientation of face exceeds a threshold from the candidates for the representative face icon images. For example, if an angle in the horizontal direction of the face is important, a relatively large threshold is set for the angle in the vertical direction of the face. As a result, some deviation in the vertical direction is permitted, and a relatively large number of images remain as the candidates for the representative face icon images in relation to the vertical direction.

The CPU 11 then removes images in which the horizontal orientation of face exceeds a threshold from the candidates for the representative face icon images. For example, the CPU 11 sets an angle range near a predetermined angle (for example, 15 degrees to the right) so that the orientations of the faces are uniform to the right and removes the images exceeding the angle range from the candidates for the representative face icon images.

The CPU 11 then determines whether there is a remaining candidate for the representative face icon image (step S34). If a candidate for the representative face icon image remains, the CPU 11 ends the filtering process. If a candidate does not remain, the CPU 11 sets an image, in which the orientation of face is relatively close to the threshold, as the candidate for the representative face icon image in step S35.

If there is no face image facing to the right in the cluster, the CPU 11 determines in step S34 that a candidate of the representative face icon image does not remain. Therefore, in that case, an image, in which the orientation of face is close to the angle range set in step S33, among the images facing to the left or facing the front is set as a candidate for the representative face icon image. An image, in which the degree of frontality is within a threshold (for example, within 15 degrees from the front side) may be left as a candidate for the representative face icon image in step S35.

If it is determined in step S34 that a candidate for the representative face icon image does not remain, the threshold of step S33 may be changed to enlarge the range of selectable images, and the process of step S33 may be executed again.

The order of the filtering processes S31, S32, and S33 shown in FIG. 10 may be switched.

Subsequently, the CPU 11 selects a representative face icon image with reference to the evaluation values based on the evaluation items of Chart 1, etc. from among the candidates for the representative face icon images in which the orientation of face is narrowed down to a predetermined range by the filtering process of FIG. 10.

In another example of the filtering process, a color image may be preferentially set as a candidate for the representative face icon image.

The main analysis is based on luminance information in the face detection process. If the evaluation values in the face detection process are used to select the representative face icon images, monotone images, such as sepia, gray scale images, black and white images, etc. may be selected. The appearance may not be good if the images and color representative face icon images are mixed.

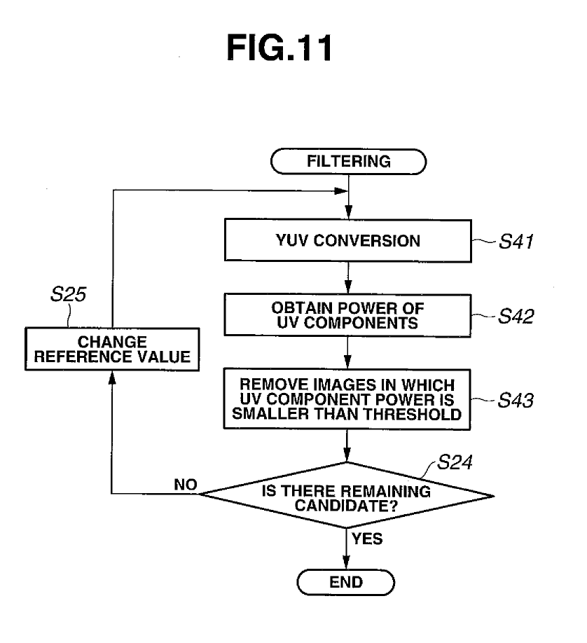

In that case, the CPU 11 can execute a filtering process shown in a flow chart of FIG. 11 in place of or in addition to the filtering process of FIG. 6.

More specifically, in step S41 of FIG. 11, the CPU 11 applies YUV conversion to the face cut-out images in each cluster to separate the images into luminance and tone. The CPU 11 then obtains power of UV components as tone components (step S42). In step S43, the CPU 11 determines images in which the power of the UV components are smaller than a threshold as black and white images or monotone/gray scale images and removes the images from the candidates for the representative face icon images.

The processes of steps S24 and S25 are the same as in FIG. 6. The CPU 11 selects representative face icon images with reference to the evaluation values based on the evaluation items of Chart 1, etc. among the face cut-out images determined to be color images in the filtering process of FIG. 11.

If color images are not included in the clusters, black and white images or monotone images remain as the candidates for the representative face icon images by changing the reference values in step S25.

In this way, various items other than the items shown in FIG. 6 can be adopted as the items used in the filtering process. For example, the degree of smile shown in Chart 1 can be adopted as an item of the filtering process.

In the present embodiment, the representative face icon images can be selected and displayed based on various evaluation items. As a result, the user can easily see the images, i.e. the user can easily recognize who are the characters. The appearance is improved, and a beautiful screen can be formed.

### Second Embodiment

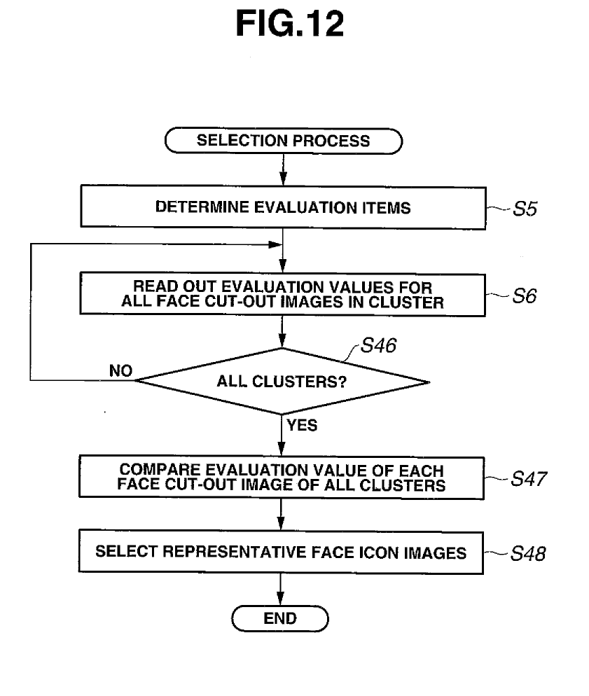

FIG. 12 is a flow chart showing a second embodiment of the present invention. A hardware configuration of the present embodiment is the same as in the first embodiment. In the present embodiment, only a selection method of the representative face icon images is different from the one of the first embodiment.

In the first embodiment, various evaluation values related to the face cut-out images in the clusters are compared to each other to select optimal face cut-out images. Furthermore, in the present embodiment, face cut-out images with uniformity between the clusters are selected.

The processes of steps S5 and S6 of FIG. 12 are the same as in the first embodiment, and the CPU 11 reads out the evaluation values of all face cut-out images in relation to the determined evaluation items. In step S46, the CPU 11 further determines whether the evaluation values of all clusters are read out. If reading of the evaluation values of all clusters is completed, the CPU 11 compares the evaluation values of the face cut-out images of all clusters (step S47). In step S48, the CPU 11 selects the face cut-out images with uniformity between the clusters as the representative face icon images of the clusters based on the comparison result of the evaluation values.

For example, if the degree of smile is selected as an evaluation item, the face cut-out image with the highest degree of smile in each cluster can be displayed as the representative face icon image of the cluster in the first embodiment. However, the degree of smile may vary between the clusters in this case.

On the other hand, the degrees of smile of the representative face icon images selected in all clusters can be matched in the present embodiment. As a result, the representative face icon images of all clusters are uniformly displayed.

In this way, images with uniformity can be selected and displayed as the representative face icon images of all clusters in the present embodiment. The display of the representative face icon images with uniformity allows the user to easily see the images, i.e. easily recognize who are the characters. Furthermore, the appearance is improved, and a beautiful screen can be constituted.

### Third Embodiment

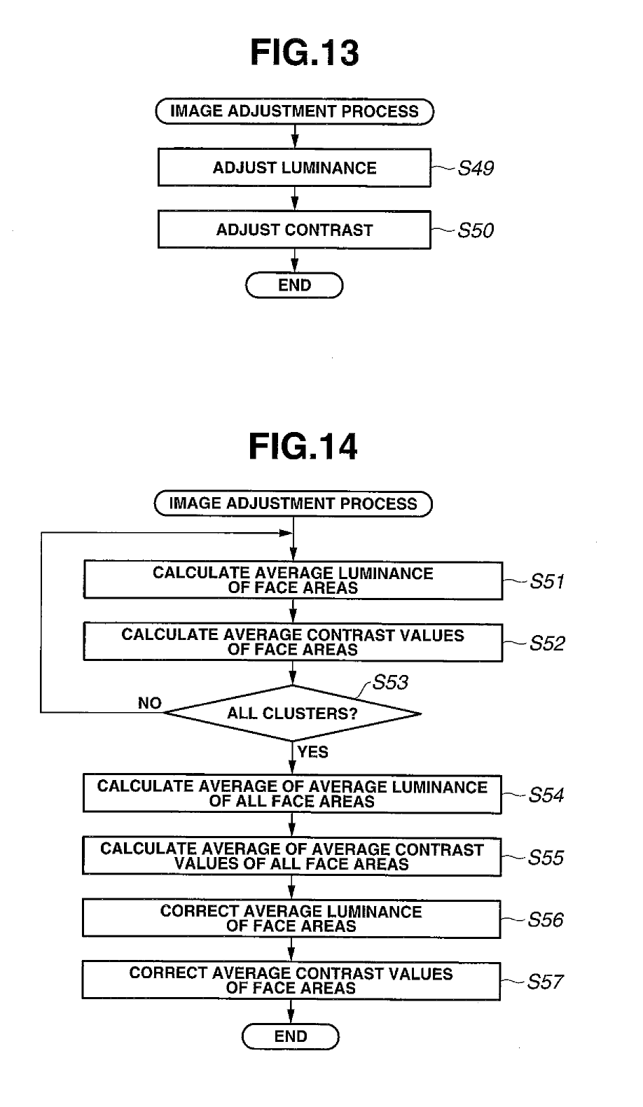

FIG. 13 is a flow chart showing a third embodiment of the present invention. A hardware configuration in the present embodiment is the same as in the first embodiment. In the present embodiment, only a display method of the representative face icon images is different from the one of the first embodiment.

In the first and second embodiments, optimal face cut-out images in the clusters are selected in accordance with the evaluation items to set the representative face icon images. However, the quality of the face cut-out images extracted from the video content may not be sufficient. Therefore, in the present embodiment, the quality, etc. of the selected face cut-out images is corrected, and then the images are displayed as the representative face icon images.

In step S49 of FIG. 13, the CPU 11 adjusts average luminance of the selected face cut-out images. In step S50, the CPU 11 further adjusts average contrast of the selected face cut-out images. As a result, the average luminance and the average contrast of the displayed representative face icon images are adjusted, and easily viewable representative face icon images with sufficient luminance and contrast can be displayed.

In this way, the representative face icon images can be displayed after the correction of the quality, etc. of the face cut-out images in the video content in the present embodiment. The display quality can be further improved.

### Fourth Embodiment

FIG. 14 is a flow chart showing a fourth embodiment of the present invention. A hardware configuration in the present embodiment is the same as in the first embodiment. In the present embodiment, only a display method of the representative face icon images is different from the one of the third embodiment.

In the third embodiment, the image quality, etc. of the selected face cut-out images is adjusted, and then the representative face icon images are displayed. In the present embodiment, the display of the representative face icon images with uniformity between the clusters in relation to the image quality, etc. is further possible. In FIG. 14, an example of obtaining uniform representative face icon images based on the average luminance and the average contrast value will be described. However, various image adjustment processes for obtaining uniform representative face icon images can be considered.

In step S51 of FIG. 14, the CPU 11 computes average luminance of the face areas of the selected face cut-out images of each cluster. In step S52, the CPU 11 computes an average contrast value of the face areas of the selected face cut-out images of each cluster. The CPU 11 then determines whether the average luminance and the average contrast values are calculated for all selected face cut-out images of all clusters (step S53) and repeats steps S51 and S52 to compute the average luminance and the average contrast values of the selected face cut-out images of all clusters.

In step S54, the CPU 11 computes an average of the average luminance of the face areas of all selected face cut-out images of all clusters. The CPU 11 then computes an average of the average contrast values of the face areas of all selected face cut-out images of all clusters in step S55.

In step S56, the CPU 11 corrects the average luminance to make the average luminance of the selected face cut-out images of each cluster equal to the average of the average luminance obtained in step S54. Similarly, in step S57, the CPU 11 corrects the average contrast values to make the average contrast value of the selected face cut-out images of each cluster equal to the average contrast value obtained in step S55. The CPU 11 uses the face cut-out images in which the average luminance and the average contrast values are corrected as the representative face icon images in a display process.

In this way, the average luminance and the average contrast values of the face cut-out images are corrected so as to match with the average of the average luminance and the average of the average contrast values in the face areas of the selected face cut-out images of the clusters. As a result, the representative face icon images between the clusters are extremely uniform in terms of the average luminance and the contrast value, and the display quality is significantly improved. This allows not only to select optimal face cut-out images, but also to display uniform images as the representative face icon images after the adjustment of the luminance and the contrast. Since the uniform representative face icon images can be displayed, the user can easily see the images, i.e. easily recognize who are the characters. Furthermore, the appearance is improved, and a beautiful screen can be constituted.

In the third and fourth embodiments, it is obvious that the average luminance and the average contrast values can be obtained for the face areas of the face cut-out images or for the entire face cut-out images.

Although an example of adjusting the average luminance and the average contrast values has been described in the embodiments, the tone may be adjusted. In a TV drama, etc., illumination conditions change when photographic scenes change, and illumination colors change. Images may be taken by intentionally changing the tone. Therefore, the tone of the selected face cut-out images may be different in each cluster. Even in that case, adjusting the tone of the face cut-out images to set the representative face icon images allows easily viewable display with uniformity.

According to the third and fourth embodiments, an image adjustment process corresponding to various evaluation items of Chart 1, etc. can be executed. For example, although an example of adjusting the image quality is illustrated in FIGS. 13 and 14, various adjustment items can be considered without limitation to the image quality.

For example, in the first embodiment, the orientation of face can be selected as an evaluation item, and for example, face cut-out images facing to the right, etc. can be selected as the representative face icon images. However, the face cut-out images facing to the right may not exist in the clusters. Therefore, if there is no face cut-out image facing to the right, the face of an image facing to the left may be horizontally reversed, or a face facing the front may be three-dimensionally converted into a face facing to the right in the third and fourth embodiments to set the representative face icon images.

An example of selecting color representative face icon images has been described in the first embodiment. However, color face cut-out images may not exist in the clusters. In that case, the fourth embodiment may be applied to convert all color representative face icon images into gray scale black/white images for display.

### First Modified Example

As described, the face clustering process is a process of creating subspaces from normalized images of all detected face cut-out images and calculating the similarity between the subspaces of the face sequences to merge the face sequences. A similarity matrix, in which the face sequences are vertically and horizontally aligned, is created, the similarity of the subspaces of the face sequence is calculated in a round robin manner, and the face sequences, in which the similarity is greater than a predetermined threshold, are integrated.

Therefore, the processing time of the similarity calculation is enormous when the face clustering process is applied to long-time video content or when the face clustering process is applied to video content with many characters. The number of calculations of the similarity calculation is proportional to the square of the number of face cut-out images.

Therefore, in the present modified example, the video content is partitioned by predetermined time intervals, and the face clustering process is executed for each partition. In that case, the CPU 11 first detects a large gap in the video content. For example, the CPU 11 sets a partition of a program of EPG or an ON/OFF point of a recording button in the case of personal video as a partition location. The “large gap” is temporally sufficiently longer than a cut point of a camera.

If there is no large gap in the video content, the CPU 11 sets the partitions by a predetermined time, such as every 60 minutes or every 30 minutes. The user may designate the partitions.

The CPU 11 carries out the face clustering process for each partition. Since the face clustering process is executed based on the partitions, the size of the similarity matrix can be reduced. As a result, the processing time of the face clustering process can be significantly shortened.

Even if the number of face sequences included in the video content is extremely large, most face cut-out images may only include a relatively small number of face sequences. Therefore, a method can be considered, in which only a top predetermined number (for example, 100) of face sequences in terms of the number of face cut-out images may be used for the face clustering process. This can significantly shorten the processing time of the face clustering process.

A method can also be considered, in which only the face sequences including more than a predetermined number (for example, 300) of face cut-out images is used for the face clustering process. The processing time of the face clustering process can also be significantly shortened in this case.

Furthermore, a method with a combination of the two methods can be considered, in which the video content is partitioned, and only the face sequences with many face cut-out images are used in each partition to execute the face clustering process. This can further shorten the processing time of the face clustering process.

### Second Modified Example

Another modified example is a method of hierarchically executing an integration process of the face sequences. More specifically, a similarity matrix between small partitions is created, and the similarity between the face sequences is calculated to execute the integration process of the face sequences. The face sequences of the partitions, to which the integration process is applied, are aligned in rows and columns to generate a large similarity matrix, and the similarity between the face sequences is calculated in the same way to execute the integration process of the face sequences. If the integration process of a first stage is finished, the size of the similarity matrix of a second stage is smaller. Therefore, the processing time of the integration process of the second stage can be shortened. The size of the similarity matrix can be further reduced by sampling the processing result of the first stage to use the result in the second stage, such as by using, in the integration process of the second stage, only top face sequences in terms of the number of included face cut-out images in the similarity matrix, in which the integration process of the first stage is finished, as described in the first modified example. The hierarchization procedure is possible not only in two stages, but also in an arbitrary number of stages. This can significantly shorten the processing time of the face clustering process.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image display apparatus comprising:
a face clustering processing section configured to group a plurality of face cut-out images included in video content by respective characters of the video content to classify clusters corresponding to the characters;
an evaluation section configured to obtain evaluation values by evaluating the plurality of face cut-out images in relation to one or more evaluation items among a plurality of evaluation items; and
a selection section configured to select the face cut-out images in which the evaluation values are within a predetermined range from among the plurality of face cut-out images in the clusters as representative face icon images used for display.

2. The image display apparatus according to claim 1, wherein
the evaluation section evaluates the plurality of face cut-out images by setting at least one of degree of frontality, average luminance, tone, focus, background, orientation of face, contrast, image location, front light, color, and smile of the face cut-out images as the evaluation item.

3. The image display apparatus according to claim 1, wherein
the selection section uses a common value as the predetermined range for the clusters corresponding to the characters.

4. The image display apparatus according to claim 1, further comprising
an image adjustment section configured to perform image adjustment for the representative face icon images selected by the selection section.

5. The image display apparatus according to claim 4, wherein
the image adjustment section computes an average of at least one of average luminance and average contrast values of face areas of all face cut-out images selected by the selection section and corrects at least one of the average luminance and the average contrast of the all face cut-out images to coincide with the computed average.

6. The image display apparatus according to claim 4, wherein
the image adjustment section performs common adjustment as the image adjustment in relation to the clusters corresponding to the characters.

7. An image display apparatus comprising:
a face clustering processing section configured to group a plurality of face cut-out images included in video content by respective characters of the video content to classify clusters corresponding to the characters;
an evaluation section configured to obtain evaluation values by evaluating the plurality of face cut-out images in relation to a plurality of evaluation items; and
a selection section configured to select the face cut-out images from the clusters based on a plurality of evaluation values in relation to the plurality of evaluation items to set representative face icon images used for display.

8. The image display apparatus according to claim 7, wherein
the evaluation section evaluates the plurality of face cut-out images by setting at least two of degree of frontality, average luminance, tone, focus, background, orientation of face, contrast, image location, front light, color, and smile of the face cut-out images as the evaluation items.

9. The image display apparatus according to claim 7, wherein
the selection section uses a common value as the predetermined range for the clusters corresponding to the characters.

10. The image display apparatus according to claim 7, wherein
the selection section
comprises a filtering section configured to remove images not set as candidates for the representative face icon images among the face cut-out images in the clusters based on the evaluation values and
determines the representative face icon image from the candidates of the representative face icon images based on the evaluation values.

11. The image display apparatus according to claim 10, wherein
the filtering section weights and adds the evaluation values in relation to the plurality of evaluation items and compares the evaluation values with a threshold to determine the candidates for the representative face icon images to be removed.

12. The image display apparatus according to claim 10, wherein
the filtering section preferentially sets color images as the candidates for the representative face icon images.

13. The image display apparatus according to claim 10, wherein
the filtering section numerically expresses orientations of faces in the face cut-out images and removes images in which values indicating vertical orientations of the faces exceed a threshold from the candidates for the representative face icon images.

14. The image display apparatus according to claim 7, further comprising
an image adjustment section configured to perform image adjustment for the representative face icon images selected by the selection section.

15. The image display apparatus according to claim 14, wherein
the image adjustment section computes an average of at least one of average luminance and average contrast values of face areas of all face cut-out images selected by the selection section and corrects at least one of the average luminance and the average contrast of the all face cut-out images to coincide with the computed average.

16. The image display apparatus according to claim 14, wherein
the image adjustment section performs common adjustment as the image adjustment in relation to the clusters corresponding to the characters.

17. An image display method comprising:
detecting face areas included in video content to generate face cut-out images including the face areas;
grouping a plurality of face cut-out images included in the video content by respective characters of the video content to classify clusters corresponding to the characters;
obtaining evaluation values by evaluating the plurality of face cut-out images in relation to one or more evaluation items among a plurality of evaluation items corresponding to a plurality of features included in the face cut-out images; and
selecting the face cut-out images in which the evaluation values are within a predetermined range from among the plurality of face cut-out images in the clusters as representative face icon images used for display.

18. An image display method comprising:
detecting face areas included in video content to generate face cut-out images including the face areas;
grouping a plurality of face cut-out images included in the video content by respective characters of the video content to classify clusters corresponding to the characters;
obtaining evaluation values by evaluating the plurality of face cut-out images in relation to a plurality of evaluation items corresponding to the plurality of features included in the face cut-out images; and
selecting the face cut-out images from the clusters based on a plurality of evaluation values in relation to the plurality of evaluation items to set representative face icon images used for display.

19. The image display method according to claim 17, wherein
if there is no face cut-out image, in which the evaluation value is within the predetermined range, among the plurality of face cut-out images in the selection of the face cut-out images from the clusters, a condition in the predetermined range is alleviated to select one or more representative face icon images.

20. The image display method according to claim 18, wherein
if there is no face cut-out image, in which the evaluation value is within the predetermined range, among the plurality of face cut-out images in the selection of the face cut-out images from the clusters, a condition in the predetermined range is alleviated to select one or more representative face icon images.
